(19) United States
(12) Patent Application Publication
(10) Pub. No.: US 2026/0228146 A1
(43) Pub. Date: Aug. 6, 2026

(54) SAFE AND EFFICIENT FORWARDING OF LINK TRAINING CONTENT

(71) Applicant: NVIDIA Corporation, Santa Clara, CA (US)

(72) Inventors: Leon Bruckman, Petah Tikva (IL); Stanislav Gurtovoy, Nesher (IL); Guy Lederman, Ness Ziona (IL); Ran Ravid, Tel Aviv (IL); Zvi Rechtman, Petah-Tikva (IL); Gil Golan, Netanya (IL); Casper Dietrich, Roskilde (DK); Lavi Koch, Tel Aviv (IL)

(21) Appl. No.: 19/042,516

(22) Filed: Jan. 31, 2025

(51) Int. Cl. G06F 13/36

(52) U.S. Cl. CPC G06F 13/36; G06F 2213/40

(57) ABSTRACT

A method includes initiating a link training process to train a transmitter equalizer, receiving a first block of data includes a plurality of pages of data each associated with tap settings of the transmitter equalizer, sending a first acknowledgement message that indicates correct receipt of the first block of data, and after sending the first acknowledgement message, receiving a second block of data includes one or more pages of data each associated with the tap settings of the transmitter equalizer.

### TECHNICAL FIELD

At least one embodiment pertains to link training over a wired connection.

### BACKGROUND

Wired communication interfaces commonly employ a process called “link training” to ensure reliable data transmission over lossy channels. As signals travel through cables or backplanes, they often encounter attenuation and distortion, causing errors at high data rates. During link training, the receiver measures signal quality and sends adjustment requests to a peer transmitter. The transmitter then tunes its equalizer—often via adjustable tap settings—to compensate for channel losses. This iterative process helps maintain robust signal integrity and minimizes bit errors, enabling higher data rates over longer distances.

### BRIEF DESCRIPTION OF THE DRAWINGS

FIG. 1 illustrates a network with a peer transmitter and a peer receiver with link training logic, according to one embodiment.

FIG. 2 illustrates tap configuration data configured into a message, according to one embodiment.

FIG. 3 illustrates another embodiment of tap configuration data configured into a message.

FIG. 4 is a flowchart illustrating the link training logic from the perspective of the peer transmitter, according to one embodiment.

FIG. 5 is a flowchart illustrating the link training logic from the perspective of the peer receiver, according to one embodiment.

FIG. 6 is a flowchart illustrating a method of receiving a message containing data to configure tap settings of a transmitter equalizer, according to one embodiment.

FIG. 7 is a flowchart illustrating a method of receiving a training message during a link training process, according to one embodiment.

FIG. 8 is a flowchart illustrating a method of sending a training message during a link training process, according to one embodiment.

FIG. 9A illustrates an example communication system, in accordance with at least some embodiments.

FIG. 9B illustrates a block diagram of an example communication system, according to at least one embodiment.

FIG. 10 illustrates an example computer system including a spectrum hardware engine and an error correction block according to at least one embodiment.

FIG. 11 is a block diagram of a computing system having two processing devices coupled to each other and multiple networks according to at least one embodiment.

FIG. 12 is a block diagram of a computing system having a central processing unit (CPU) and a graphics processing unit (GPU) in a single integrated circuit according to at least one embodiment.

FIG. 13 is a block diagram of a computing system having tensor core graphics processing units (GPUs) according to at least one embodiment.

### DETAILED DESCRIPTION

Standard link training allows a peer receiver to configure a peer transmitter equalizer to achieve basic performance. In many cases, this basic performance is inadequate. Tuning the equalizer coefficients may not be enough, and full control of the peer transmitter equalizer may be required. Full control may be achieved using a look up table (LUT) with tap configuration data (e.g., tap settings or tap coefficients). However, LUTs may be large (e.g., 2 kilobits (Kb) or more depending on the equalizer design). Conventionally, sending such a large LUT using standard link training procedures can be slow—especially if the link has low performance. This is because, during conventionally standard link training, the peer receiver conveys tap configuration data to the peer transmitter by sending this information in discrete chunks referred to herein as pages. Typically, these pages are separated by large amounts of pseudo-random binary sequence (PRBS) data used as test patterns by the peer receiver. After transmitting a single page of tap configuration data (sometimes sending the same page of tap configuration data several times), the peer receiver waits for an acknowledgment from the transmitter confirming receipt. This acknowledgment may confirm correct receipt (ACK) or incorrect receipt (NACK) of the page of tap configuration data. If a NACK message is received, the peer receiver resends the same page of configuration data to the peer transmitter. Conversely, if an ACK message is received, the peer receiver sends the next page of tap configuration data to the peer transmitter. Conventionally, the peer receiver proceeds to send the next page of tap configuration data only after the peer receiver obtains an acknowledgment confirming correct receipt of the previous page of tap configuration data. While such standard link training ensures that the peer transmitter properly processes and applies each page of tap configuration data before moving on to the next page, this page-by-page reception and acknowledgement is time-costly, heavily dependent on the link length as each request/response needs a full round trip time (RTT), and inefficient if a large amount of data is to be sent to the peer transmitter.

Aspects and embodiments of the present disclosure address the above problems and other by providing an improved link training process that allows the peer transmitter to acknowledge receipt of a block of pages simultaneously instead of the peer transmitter acknowledging receipt page-by-page. The improved link training process may allow the peer receiver to send multiple pages of tap configuration data before the peer transmitter is required to acknowledge receipt. This adjustment significantly improves the speed by which the LUT is sent from the peer receiver to the peer transmitter.

However, conventionally, the peer transmitter is unable to keep track of multiple pages of tap configuration data. Because standard link training requires an ACK message before the peer receiver sends the next page of tap configuration data, the peer transmitter conventionally has no need to keep track of multiple pages of tap configuration data. As a result, conventional link training processes are not capable of tracking multiple pages of tap configuration data that are all received before an ACK message is sent to the peer receiver. One possible solution to this problem includes the peer transmitter parsing through each newly-received page to determine whether it is substantially similar to the previous page, and if not, determining that the newly-received page is a new page. However, this requires that each sequential page of tap configuration data be dissimilar, and also may require substantial processing power.

Aspects and embodiments of the improved link training process may include providing an improved page is provided that uses a standard page structure (e.g., as provided by IEEE 802.3dj Annex 178B) but with different contents. These different contents may optimize an amount of data exchanged in each page. The improved page may be identified using one or more reserved bits of the standard page structure.

Aspects and embodiments of the improved link training process include systems and methods of tracking such received pages as described above. In at least some embodiments, the improved link training process adds a page control field to the overhead of each page that indicates whether a page is a first-received page corresponding to the LUT (e.g., 10), whether the page is corresponds to the LUT but is not the first-received page or a last-received page (e.g., 01 or 00, alternating), or whether the page is the last-received page corresponding to the LUT (e.g., 11). The page control field may allow the peer transmitter to detect when a new page is received, rather than a same page being repeated.

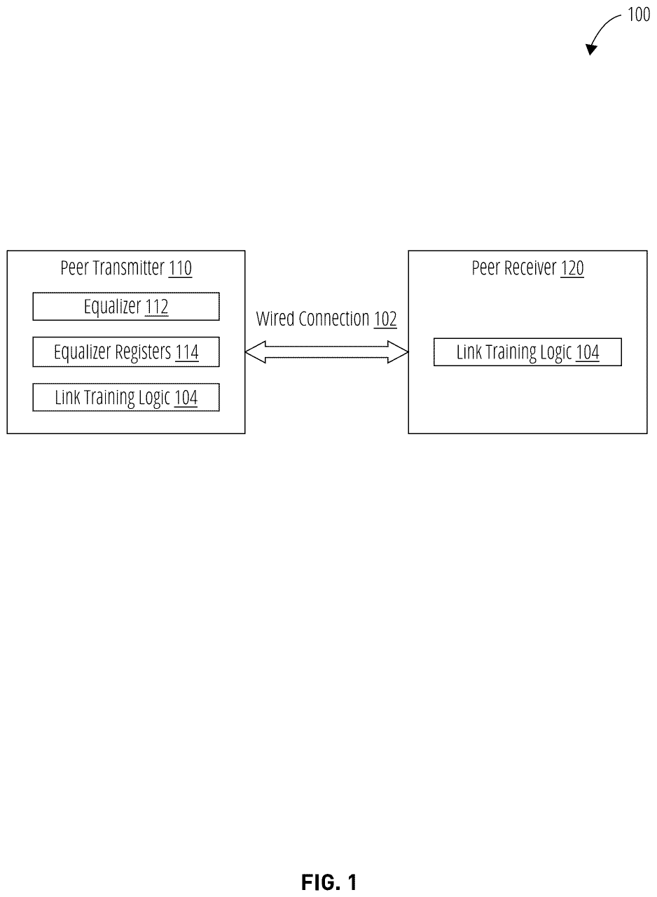

FIG. 1 illustrates a network 100 with a peer transmitter 110 and a peer receiver 120 with link training logic 104, according to one embodiment. The peer transmitter 110 and peer receiver 120 may be coupled together via a wired connection 102. In some embodiments, this wired connection 102 may be an Ethernet® connection. The peer transmitter 110 and peer receiver 120 may communicate via serializer/deserializer (SerDes) techniques and technologies. In at least some embodiments, the peer transmitter 110 and peer receiver 120 may each include a SerDes interface. Generally, SerDes transforms wide parallel data within a transmitting device into a serial stream for transmission, which is then reassembled into parallel form at the receiving device. When data is sent from the peer transmitter 110 to the peer receiver 120 (or vice versa), the data first passes through a serializer, which sequentially converts parallel data bits into a serial bitstream. At higher throughput rates, such as multi-gigabit rates, the signal traveling across the channel can encounter frequency-dependent attenuation, reflections, and other distortions that make accurate data recovery more difficult at the receiver. Additionally, a physical channel may be subject to impedance mismatches or other types of channel losses which can also impair the ability of the peer receiver 120 to correctly recover the transmitted data. To mitigate these impairments, the peer transmitter 110 may employ an equalizer 112, often implemented as a multi-tap filter that shapes the transmitted signal to compensate for anticipated channel losses and distortions. The filter taps—commonly referred to as pre-cursor, main tap, and post-cursor taps—are assigned numerical coefficients called tap settings or tap values. These tap coefficients are used by the equalizer 112 to determine how much the transmitted signal is boosted or attenuated at various time offsets relative to the main bit, helping to counteract the intersymbol interference (ISI) caused by the physical channel.

Once the peer transmitter 110 has applied the prescribed tap settings, the shaped signal is driven onto the differential pair lines toward the peer receiver 120. Inside the peer receiver 120, an analog front end (AFE) can further refine and restore the incoming signal. This AFE can also include one or more of Continuous-Time Linear Equalizers (CTLEs), Variable Gain Amplifiers (VGAs), and sometimes decision feedback equalizers (DFEs), all of which help to correct remaining signal distortions. Because the transmitted bitstream may also embed timing information, clock data recovery (CDR) circuitry extracts a timing reference from the incoming waveforms and aligns the bit decisions accordingly. Then, a deserializer at the peer receiver 120 may convert the high-speed serial data back into a parallel format for local use.

In some embodiments, the peer transmitter 110 and peer receiver 120 may include link training logic 104 that allows the peer receiver 120 to optimize the tap settings of the peer transmitter 110 through a link training process. Some or all of the operations described herein related to link training may be performed at least partially by the link training logic 104. During link training, the peer receiver 120 may observe the quality of the incoming signal (e.g., tracking error rates or eye openings) and determine whether adjusting the tap settings of the equalizer 112 will improve performance. In some embodiments, the peer receiver 120 may generate optimized tap settings for the equalizer 112 in the form of a look-up table (LUT). These optimized tap settings may be referred to as tap configuration data. Tap configuration data may communicate tap adjustments in various ways. For example, the tap configuration data may provide increase or decrease commands that allows the peer transmitter 110 to make small adjustments and iterate toward an optimal solution. In another example, the tap configuration data may include tap values that the peer receiver 120 has determined to be optimal tap settings (e.g., absolute best coefficients) that replace the existing tap settings of the peer transmitter 110. In another example, the tap configuration data includes delta values that indicate how much each tap should increase or decrease. Another example may include a feedback or error-signal mechanism, where tap configuration data includes an error gradient that the peer transmitter 110 relies on to adjust its tap settings based on that feedback. Hybrid tap configuration data may include any of the above examples and others, such as combining coarse initial settings (to quickly lock in decent performance) with incremental updates for fine-tuning. Another example is a non-linear look-up table (LUT) that refers to a type of signal processing device that uses a pre-calculated table of values to correct for non-linear distortions in a signal, essentially applying a non-linear transformation to the data based on the input value, rather than a simple linear scaling, to achieve better signal quality in situations where the distortion cannot be effectively addressed by a standard linear equalizer.

If the equalizer 112 would benefit from updated tap settings, the peer receiver 120 may send the LUT (i.e., the tap configuration data) to the peer transmitter 110. The peer receiver 120 may send the LUT or other tap configuration data to the peer transmitter 110 via a training message, as described herein. In some embodiments, the peer receiver 120 may send training messages to the peer transmitter 110 at regular intervals, even in some cases outside of any link training procedure. Depending on the size of the training message, the tap configuration data may need to be organized into a message containing pages and blocks. One page may include a certain amount of tap configuration data (e.g., 12 bits), and each block may include multiple pages. The peer receiver 120 may send these blocks and pages to the peer transmitter 110 in a sequential manner. After transmitting a block, the peer receiver 120 may wait for an acknowledgement frame from the peer transmitter 110 that either confirms receipt of the block (block ACK) or requests that the block be resent (negative block ACK, or block NACK). Once the peer receiver 120 has transmitted the entirety of the message to the peer transmitter 110, the peer receiver 120 may wait for another acknowledgement frame from the peer transmitter 110 that either confirms receipt of the message (message ACK) or requests that the entire message be resent (message NACK). The peer transmitter may determine that the message has been correctly receive by one or more of verifying the overall message length (i.e., by comparing the length of the message to an expected length) or via optional CRC error detection.

Once the peer transmitter 110 confirms correct receipt of the training message from the peer receiver 120 containing the tap configuration settings, the peer transmitter 110 may use the tap configuration settings to modify the stored tap settings that control the equalizer 112. In at least some embodiments, this link training process may be iteratively performed multiple times until these tap settings converge on values that minimize bit errors in the transmission of data from the peer transmitter 110 to the peer receiver 120.

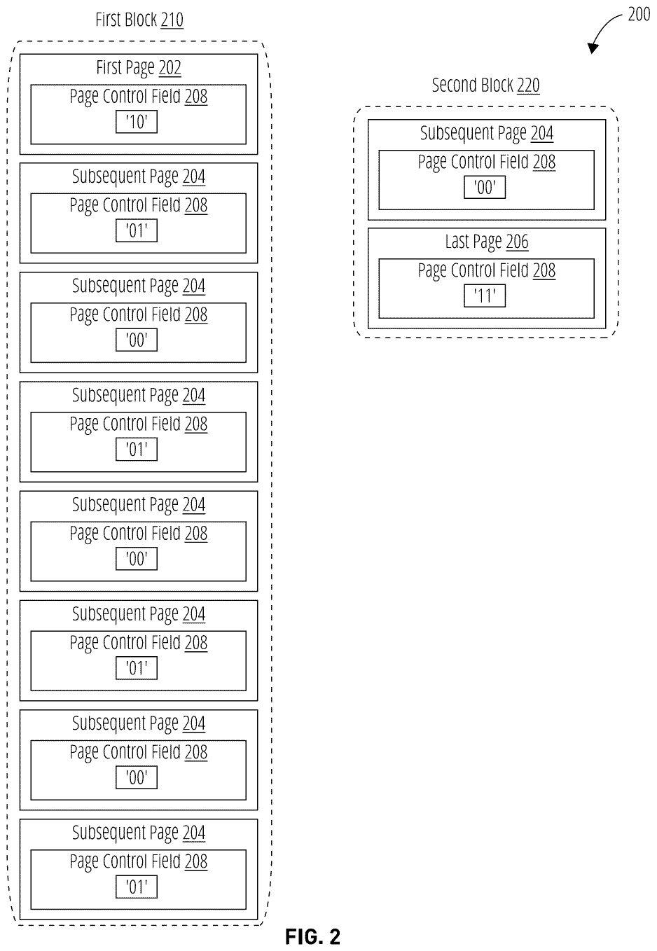

FIG. 2 illustrates tap configuration data configured into a training message 200, according to one embodiment. The training message 200 may include a first block 210 containing multiple pages 202, 204, and a second block 220 containing multiple pages 204, 206. These blocks may be referred to as subsets of the training message 200. According to embodiments, the training message 200 may include more or less than two blocks depending on how much tap configuration data is to be sent from a peer receiver to a peer transmitter during link training. For example, the training message 200 may include any number of blocks between the first block 210 and the second block 220 that includes subsequent pages 204 carrying additional tap configuration data. In at least one embodiment, each of these additional blocks may have a same number of pages as the first block 210. Each block of the training message 200 may have at least two pages. The second block 220 may have a different number of pages than the first block 210 and these additional blocks, as the training message 200 may not have a number of pages divisible by the number of pages in the first block 210. In one embodiment, the second block 220 may include one or more pages of padding so that the second block 220 has the same number of pages as the first block 210. In some embodiments, the training message 200 may be sent from the peer receiver to the peer transmitter outside of link training. In at least one of these embodiments, the training message 200 be used to send information other than tap configuration data.

The tap configuration data (or other type of data) of the training message 200 may be organized into different pages. Here, these pages may be referred to as a first page 202, subsequent pages 204, and a last page 206. Each of these pages 202, 204, 206 may have a 2-bit page control field 208 within their respective overheads that allows the peer transmitter to determine the type and order of received pages. According to embodiments, the page control field 208 contains different bit values (also referred to as page control field values) to (i) identify the first page 202 of the training message 200 that carries the type field and other information about the tap configuration data, (ii) toggle at each subsequent page 204 to guarantee a bit change for each subsequent page 204, and (iii) identify the last page 206 of the training message 200. While the page control field 208 contains two bits, the page control field 208 may utilize any number of bits to organize and denote the order of the pages. In the illustrated example, the page control field 208 of the first page 202 includes ‘10’ bit value, the page control fields 208 of the subsequent pages 204 alternate between including ‘01’ and ‘00’ bit values, and the page control field 208 of the last page 206 includes ‘11’ bit value. Here, the ‘10’ bit value identifies the first page 202, the ‘01’ and ‘00’ bit values identify sequential subsequent pages 204, and the ‘11’ bit value identifies the last page 206. In at least some embodiments, these page control field values are specified in a way that every sequential page carries a different value, which allows the peer transmitter 110 to detect a change of pages even if the page payload is the same for two or more subsequent pages. In other words, sequentially-received pages of the training message may be configured so that they do not share a same value (i.e., same page control field value). This can allow pages to be repeated several times to improve reliability, and also allow the peer transmitter 110 to detect each time a new page is transmitted by the peer receiver 120 without requiring the peer receiver to parse through each page to detect new pages.

In at least some embodiments, each subsequent bit 204 includes a payload. This payload may be a portion of the tap configuration data. In embodiments where CRC error detection is not enabled, the last page 206 may also carry a payload of a portion of the tap configuration data.

In some embodiments, a reserved bit in the overhead of these pages 202, 204, 206 may be used to indicate that a particular frame uses the page structure described and illustrated herein to carry the tap configuration data. In at least one embodiment, this reserved bit may be the same or similar as reserved bit(s) of link training frames defined by IEEE 802.3dj Annex 178B. The page structure provided herein may optimize frame contents to convey more tap configuration data per frame. In a standard page there are only three reserved bits in the control overhead field that can be used to transmit data while the control overhead field of the page described herein can carry more payload bits. For example, the page described herein may be capable of carrying more than three payload bits. In at least one embodiment, the page described herein may carry twelve payload bits.

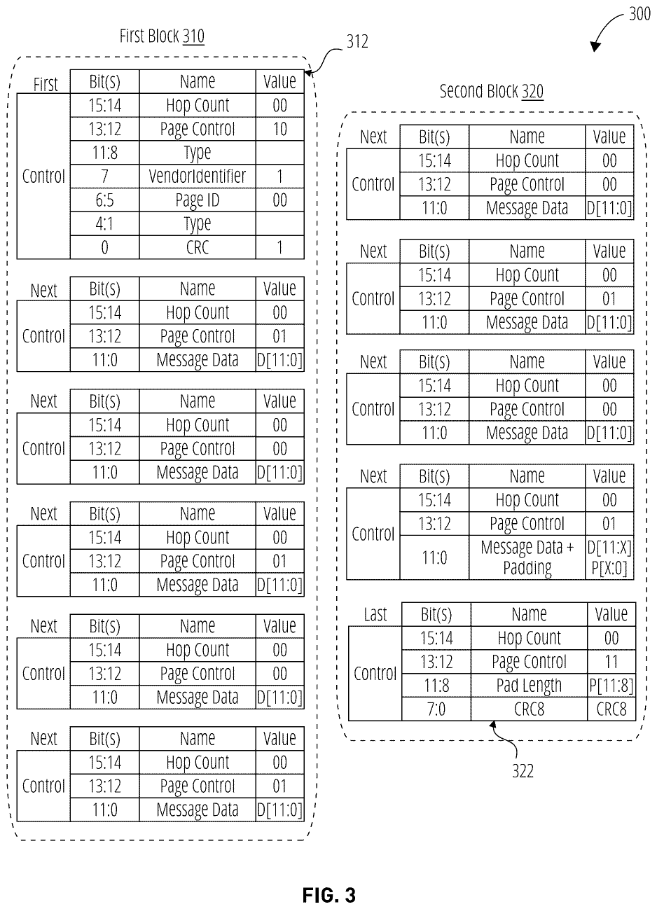

FIG. 3 illustrates tap configuration data configured into a message 300, according to one embodiment. The message 300 include some or all of the features of the training message 200 described above in FIG. 2. The message 300 may include a first block 310 and a second block 320. While pages of the message 300 are shows to have 16 bits [15:0], the pages of the message 300 may configured to have any suitable number of bits. For example, the subsequent pages 204 (as illustrated, “next” pages) may be configured to each include 28 bits of message data (e.g., tap configuration data), and each page may be configured to be made of 32 bits each.

The first block 310 may include a first page 312 that includes some or all of the features of the first page 202 described above with respect to FIG. 2. For example, the first page 312 includes a page control field (bits 13:12) that are used to identify the first page 312 as the first page of the message 300. In some embodiments, the first page 312 may include other fields, such as one or more of a hop count field, one or more type fields, a vendor identifier field, a page ID field, and a cyclic redundancy check (CRC) present field. The first page 312 may also include other fields used to identify or described what data is carried by the message 300. The hop count field may be used by intermediate nodes within a network between a peer receiver (that sends the message 300) and a peer transmitter (the intended recipient of the message 300) to ensure that the message 300 reaches the peer transmitter. This field can help ensure loop prevention and assists in routing efficiency by decrementing the count at each hop. The type field may provide context for interpreting the content of the message 300, indicating its purpose or format. For instance, the type field might classify the message 300 as containing tap configuration data, such as a LUT with tap settings. Other type fields may provide other information about the message 300 to the peer transmitter. The vendor identifier field may associate the message with a specific manufacturer or organization, enabling compatibility across heterogeneous systems while maintaining differentiation. The CRC present field may inform the peer transmitter of whether CRC error detection is provided at the end of the message 300. CRC error detection may be optional.

The second block 320 may include a last page 322 that includes some or all of the features of the last page 206 described above with respect to FIG. 2. For example, the last page 322 includes a page control field (bits 13:12) that are used to identify the last page 322 as the last page of the message 300. In some embodiments, the last page 322 may include other fields, such as one or more of a hop count field similar to the first page 312, a pad length field, and a CRC field. The pad length field and the CRC field may only be part of the last page 322 if the CRC present field of the first page 312 indicates that CRC error detection is provided at the end of the message 300. Otherwise, the last page 322 may include message data (e.g., tap configuration data) and any necessary padding, as is illustrated in the block immediately above the last page 322.

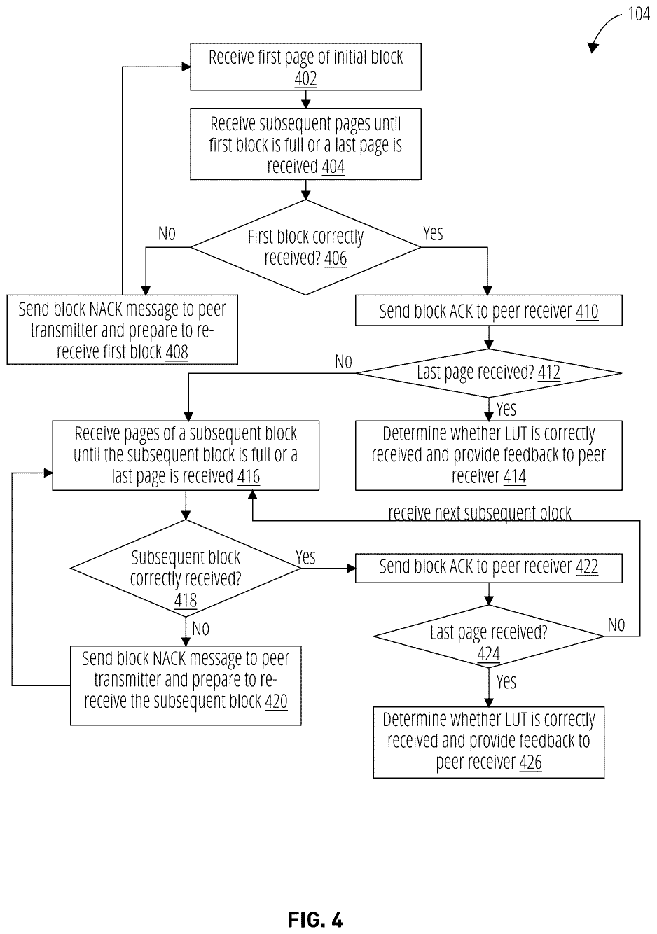

FIG. 4 is a flowchart illustrating the link training logic 104 from the perspective of the peer transmitter 110, according to one embodiment. The operations described with respect to the link training logic 104 may be performed by processing logic that may comprise hardware (e.g., circuitry, dedicated logic, programmable logic, microcode, etc.), software (e.g., instructions run on a processing device to perform hardware simulation), firmware, or a combination thereof. In some embodiments, the operations described with respect to the link training logic 104 may be performed by a serializer/deserializer (SerDes) interface that includes an equalizer. The operations described with respect to the link training logic 104 may be performed at least partially by other devices, such as one or more processors external to the SerDes interface.

At block 402, the link training logic 104 may cause the peer transmitter 110 to receive the first page of a first block. This first page may include one or more of the features of the first page 202 or first page 312 described above. The first block may include one or more of the features of the first block 210 or first block 310 described above. The link training logic 104 may identify the first page as the first page of a training message based on a unique bit value within the page control field 208. This unique bit value may be referred to as a page control field value. Because the first page is the first page of the training message, the link training logic 104 may also determine that more pages of the first block are to be received.

At block 404, the link training logic 104 may cause the peer transmitter 110 to receive subsequent pages of the message until the first block is full or a last page of the training message is received. The first block may be full once the link training logic 104 determines that the peer transmitter 110 has received a predetermined maximum number of pages per block. In some embodiments, this predetermined maximum number may be 8 pages. In other embodiments, this predetermined maximum number may be smaller or larger than 8 pages. The link training logic 104 may determine that the last page of the training message has been received if the page control field 208 of a most-recently received page contains a unique identifier corresponding with the last page of the training message, as described herein.

At decision block 406, after the peer transmitter 110 has received subsequent pages until the first block is full or the last page of the training message has been received, the link training logic 104 may determine whether the pages of the first block were correctly received. The link training logic 104 may use any suitable method or process of verifying whether the pages of the first block were correctly received. If the first block was not correctly received, the link training logic 104 causes the peer transmitter 110 to send a block negative acknowledgement (block NACK) message to the peer receiver 120, and performs any actions necessary to prepare the peer transmitter 110 to re-receive the first block at block 408. If the first block was correctly received, the link training logic 104 causes the peer transmitter 110 to send a block acknowledgement (block ACK) message to the peer receiver 120 at block 410.

At decision block 412, the link training logic 104 perform different actions based on whether the first block contained the last page of the training message. If the first block contained the last page of the training message, the link training logic 104 may determine whether the data within the training message (e.g., tap configuration data in the form of a LUT) was correctly received. The link training logic 104 may determine whether the data within the training message was correctly received by verifying the length of the training message, performing CRC error detection, and/or any other suitable technique for verifying that a message was correctly received over a SerDes channel. If the training message was correctly received, the link training logic 104 may cause the peer transmitter 110 to send a message acknowledgement (message ACK) message to the peer receiver 120. Conversely, if the training message was incorrectly received, the link training logic 104 may cause the peer transmitter 110 to send a message negative acknowledgement (message NACK) message to the peer receiver 120. The message NACK message may indicate to the peer receiver 120 that the whole training message should be resent to the peer transmitter 110.

According to embodiments, if the first block contains the last page of the training message, the operations described with respect to decision block 406, block 408, and block 410 may be unnecessary and/or optional. If the first block contains the last page of the training message, the link training logic 104 may be able to verify whether the training message was correctly received without verifying that the pages of the first block were correctly received.

At block 416, if the first block does not include the last page of the training message, the link training logic 104 may cause the peer transmitter 110 to receive pages of a subsequent block until the subsequent block is full or the last page of the training message is received. The operations of block 416 may be similar to the operations of block 404.

At decision block 418, after the peer transmitter 110 has received subsequent pages until the subsequent block is full or the last page of the training message has been received, the link training logic 104 may determine whether the pages of the subsequent block were correctly received. The link training logic 104 may use any suitable method or process of verifying whether the pages of the subsequent block were correctly received. If the subsequent block was not correctly received, the link training logic 104 causes the peer transmitter 110 to send a block NACK message to the peer receiver 120, and performs any actions necessary to prepare the peer transmitter 110 to re-receive the subsequent block at block 420. If the subsequent block was correctly received, the link training logic 104 causes the peer transmitter 110 to send a block ACK message to the peer receiver 120 at block 422. If after a threshold number of attempts of transmitting a block the transmitter sends a block NACK, the message transmission may be declared as failed.

At decision block 424, if the subsequent block was correctly received, the link training logic 104 may determine whether the subsequent block contains the last page of the training message. If the subsequent block does not contain the last page of the training message, the link training logic 104 may cause the peer transmitter 110 to receive a next subsequent block of page(s) of the training message. This next subsequent block may be received and analyzed using the operations of blocks 416, 418, 420, and 422 above. This process may be iterated (i.e., receiving additional subsequent blocks of the training message) until the subsequent block contained the last page of the training message.

At block 426, if the subsequent block contains the last page of the training message, the link training logic 104 may determine whether the data within the training message (e.g., tap configuration data in the form of a LUT) was correctly received. The link training logic 104 may determine whether the data within the training message was correctly received by verifying the length of the training message, performing CRC error detection, and/or any other suitable technique for verifying that a message was correctly received over a channel. If the training message was correctly received, the link training logic 104 may cause the peer transmitter 110 to send a message ACK message to the peer receiver 120. Conversely, if the training message was incorrectly received, the link training logic 104 may cause the peer transmitter 110 to send a message NACK message to the peer receiver 120. The message NACK message may indicate to the peer receiver 120 that the training message should be resent to the peer transmitter 110. In at least some embodiments, if after a threshold number of attempts of transmitting a block the result is a block NACK, the message transmission is declared as failed.

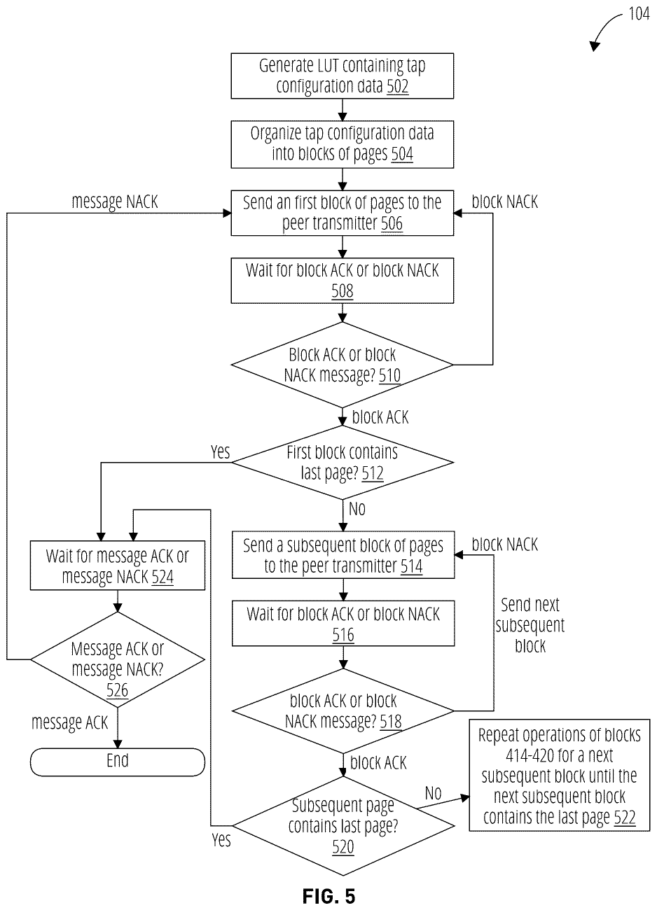

FIG. 5 is a flowchart illustrating the link training logic 104 from the perspective of the peer receiver 120, according to one embodiment. The operations described with respect to the link training logic 104 may be performed by processing logic that may comprise hardware (e.g., circuitry, dedicated logic, programmable logic, microcode, etc.), software (e.g., instructions run on a processing device to perform hardware simulation), firmware, or a combination thereof. In some embodiments, the operations described with respect to the link training logic 104 may be performed by a serializer/deserializer (SerDes) interface that includes an equalizer. The operations described with respect to the link training logic 104 may be performed at least partially by other devices, such as one or more processors external to the SerDes interface. Instructions may be stored within memory that are executed by one or more processors internal and/or external to the SerDes interface to perform the operations of the link training logic 104.

At block 502, the link training logic 104 may generate a look-up table (LUT) containing tap configuration data. This tap configuration data may be as described above. For example, the tap configuration data may include tap values that the peer receiver 120 has determined to be optimal tap settings (e.g., absolute best coefficients) that replace the existing tap settings of the peer transmitter 110. In some embodiments, the tap configuration data may be generated an analysis of signal quality metrics, such as error rates and signal integrity, observed during transmission from the peer transmitter 110 to optimize equalization for specific channel conditions.

At block 504, the link training logic 104 may organize the tap configuration data into a training message having blocks of pages. The training message may be organized to have a first page that includes one or more features of the first page 202 or first page 312 described above, subsequent pages that include one or more features of the subsequent pages 204 described above, and a last page that includes one or more features of the last page 206 or last page 322 described above. Depending on how much tap configuration data the training message is to include, the training message may include any number of blocks.

At block 506, the link training logic 104 may cause the peer receiver 120 to send a first block of the training message to the peer transmitter 110. This may include sending at least the first page and one subsequent page of the training message to the peer transmitter 110. In some embodiments, the last page may also be sent to the peer transmitter 110 within the first block.

At block 508, the link training logic 104 waits for the peer receiver 120 to receive either a block ACK message or a block NACK message from the peer transmitter 110. A block NACK means that the first block is to be re-sent to the peer transmitter 110 due to, in at least some cases, an error in transmission. A block ACK means that the first block was correctly received by the peer transmitter 110.

At decision block 512, the link training logic 104 determines whether the first block contains the last page of the training message. If the first block contains the last page of the training message, the link training logic 104 waits for a message ACK message or a message NACK message at block 524. If the first block does not contain the last page of the training message, the link training logic 104 sends a subsequent block of pages to the peer transmitter 110 at block 514.

At block 514, as described above, the link training logic 104 sends a subsequent block of pages to the peer transmitter 110 at block 514. Once the subsequent block of pages has been sent to the peer transmitter 110, the link training logic 104 waits for the peer receiver 120 to receive either a block ACK message or a block NACK message at decision block 516. Here, a block NACK means that the subsequent block is to be re-sent to the peer transmitter 110 due to, in at least some cases, an error in transmission. Conversely, a block ACK means that the subsequent block was correctly received by the peer transmitter 110.

At decision block 520, the link training logic 104 determines whether the subsequent block contains the last page of the training message. If the subsequent block contains the last page of the training message, the link training logic 104 waits for a message ACK message or a message NACK message at block 524. If the first block does not contain the last page of the training message, the link training logic 104 sends a next subsequent block of pages to the peer transmitter 110 at block 514. This process may be iterated (i.e., sending additional subsequent blocks of the training message) until the last-sent subsequent block contains the last page of the training message.

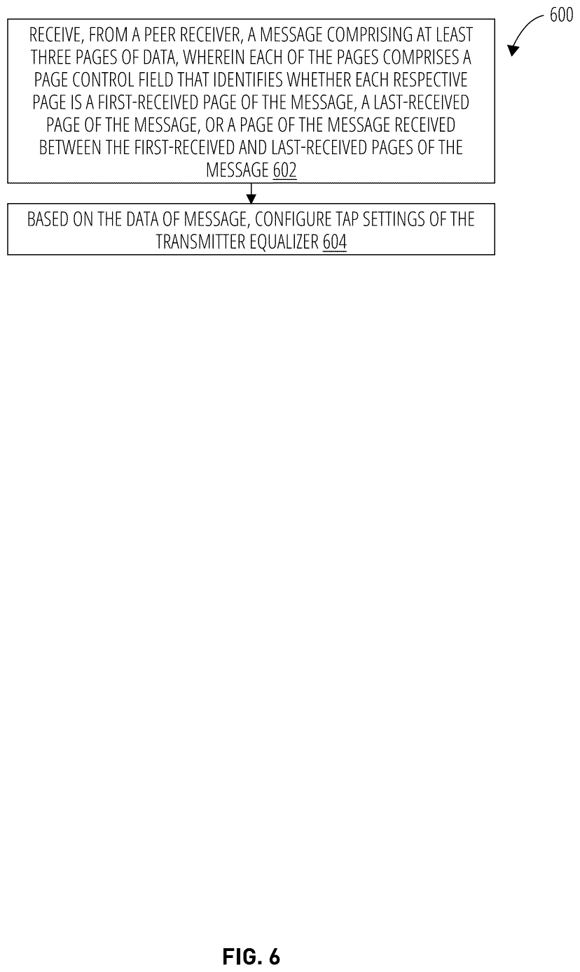

FIG. 6 is a flowchart illustrating a method 600 of receiving a training message during a link training process, according to one embodiment. The method 600 may be performed by the link training logic 104, as described herein. The link training logic 104 may include processing logic that may comprise hardware (e.g., circuitry, dedicated logic, programmable logic, microcode, etc.), software (e.g., instructions run on a processing device to perform hardware simulation), firmware, or a combination thereof. In some embodiments, the method 600 may be performed by a serializer/deserializer (SerDes) interface that includes an equalizer. The method 600 may be performed at least partially by other devices, such as one or more processors external to the SerDes interface. Instructions may be stored within memory that are executed by one or more processors internal and/or external to the SerDes interface to perform the method 600.

In block 602, the link training logic 104 may receive, from a peer receiver, a message comprising at least three pages of data. Each of these pages may include a page control field that identifies whether each respective page is a first-received page of the message (e.g., a first page 202 or first page 312 described above), a last-received page of the message (e.g., a last page 206 or last page 322 described above), or a page of the message received between the first-received and last-received pages of the message (e.g., a subsequent page 204 described above).

In at least some embodiments, pages of the message may be assigned or otherwise include page control field values such that sequentially-received pages do not share a same page control field value. For example, if a page has a page control field value of ‘01’ (e.g., a subsequent page 204), the immediate previously-received page does not have a page control field value of ‘01’. For example, this immediate previously-received page may have a page control field of ‘00’ (e.g., a subsequent page 204) or a page control field of ‘10’ (e.g., a first page 202).

At block 604, the link training logic 104 may configure tap settings of the transmitter equalizer based on the data of message.

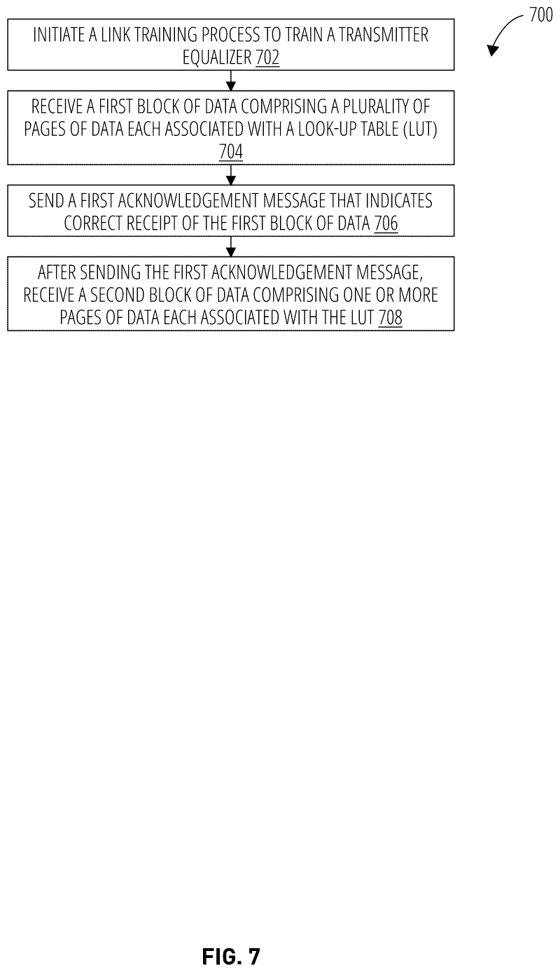

FIG. 7 is a flowchart illustrating a method 700 of receiving a training message during a link training process, according to one embodiment. The method 700 may be performed by the link training logic 104, as described herein. The link training logic 104 may include processing logic that may comprise hardware (e.g., circuitry, dedicated logic, programmable logic, microcode, etc.), software (e.g., instructions run on a processing device to perform hardware simulation), firmware, or a combination thereof. In some embodiments, the method 700 may be performed by a serializer/deserializer (SerDes) interface that includes an equalizer. The method 700 may be performed at least partially by other devices, such as one or more processors external to the SerDes interface. Instructions may be stored within memory that are executed by one or more processors internal and/or external to the SerDes interface to perform the method 700.

At block 702, the link training logic 104 may initiate a link training process to train a transmitter equalizer.

At block 704, the link training logic 104 may receive a first block of data comprising a plurality of pages of data each associated with tap settings of the transmitter equalizer. In some embodiments, to receive the first block of data, the link training logic 104 may receive a first page of the plurality of pages of data. This first page may include a first page control value that indicates that the first page is an initial page of data of a training message sent (or in the process of being sent) by a peer receiver. The training message may correspond to tap settings of the transmitter equalizer.

After (in at least some cases, immediately after) receiving the first page, the link training logic 104 may receive a second page of the plurality of pages of data includes a second page control value different from the first page control value. This second page may part of the first block or part of a second block. The second page control value may indicate that the second page is part of the training message and corresponds to the tap settings of the transmitter equalizer.

After (in at least some cases, immediately after) receiving the second page, the link training logic 104 may receive a third page of the plurality of pages of data. This third page may also be part of either the first block of pages or a subsequent block of pages. The third page may include a third page control value different from the first and second page control values. The third page control value may indicate that the third page is part of the training message and that the third page also corresponds to the tap settings of the transmitter equalizer.

After receiving the third page, the link training logic 104 may receive a fourth page of the plurality of pages of data. The fourth page may also be part of either the first block of pages or a subsequent block of pages. This fourth page may include the second page control value. In some cases, as explained above, page control values may toggle such that sequentially-received pages do not share a same page control value. This may help the peer transmitter differentiate when a new page is received from when a last-received page is repeated for transmission reduction error purposes. In other embodiments, this fourth page may include a fourth page value different from the first, second, third, and fourth page values. This fourth page value may indicate that the fourth page is a last page of data of the training message, or that the fourth page is a last page of data corresponding to the tap settings of the transmitter equalizer.

In at least some embodiments, pages received successively after the first page (in some cases, the second, third, and fourth pages) alternately include one of the second page control value or the third page control value based on an order in which the pages are received. The pages may be assigned page control values such that an immediately preceding page or an immediately previous page and the current page do not share a same page control value. Each of the remaining pages of the training message after the first page may be assigned page control values such that sequential pages do not share a same page control value.

At block 706, the link training logic 104 sends a first acknowledgement message that indicates correct receipt of the first block of data. The link training logic 104 may indicate correct receipt of the first block of data if the first block of data is correctly received. This first acknowledgement message may act as an acknowledgement message for each page of the first block.

At block 708, after sending the first acknowledgement message, the link training logic 104 may receive a second block of data comprising one or more pages of data each associated with the tap settings of the transmitter equalizer. In some embodiments, the link training logic 104 may send a second message (e.g., a second acknowledgement message) that indicates incorrect receipt of the second block of data. The second block may then be re-received. Afterwards, the link training logic 104 may send a third acknowledgement message that indicates correct receipt of the second block of data. Then, a third block with new pages of data of the training message may then be received.

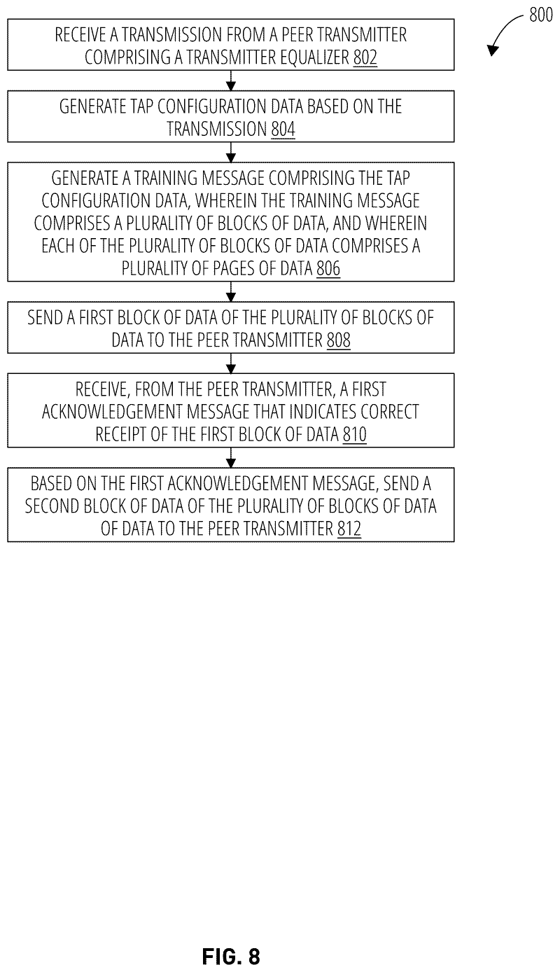

FIG. 8 is a flowchart illustrating a method 800 of sending a training message during a link training process, according to one embodiment. The method 800 may be performed by the link training logic 104, as described herein. The link training logic 104 may include processing logic that may comprise hardware (e.g., circuitry, dedicated logic, programmable logic, microcode, etc.), software (e.g., instructions run on a processing device to perform hardware simulation), firmware, or a combination thereof. In some embodiments, the method 800 may be performed by a serializer/deserializer (SerDes) interface that includes an equalizer. The method 800 may be performed at least partially by other devices, such as one or more processors external to the SerDes interface. Instructions may be stored within memory that are executed by one or more processors internal and/or external to the SerDes interface to perform the method 800.

At block 802, the link training logic 104 may receive a transmission from a peer transmitter comprising a transmitter equalizer.

At block 804, the link training logic 104 may generate tap configuration data based on the transmission.

At block 806, the link training logic 104 may generate a training message comprising the tap configuration data. The training message may include a plurality of blocks of data, and each of the plurality of blocks of data may include a plurality of pages of data.

At block 808, the link training logic 104 may send a first block of data of the plurality of blocks of data to the peer transmitter.

At block 810, the link training logic 104 may receive, from the peer transmitter, a first acknowledgement message that indicates correct receipt of the first block of data.

At block 812, based on the first acknowledgement message, the link training logic 104 may send a second block of data of the plurality of blocks of data of data to the peer transmitter.

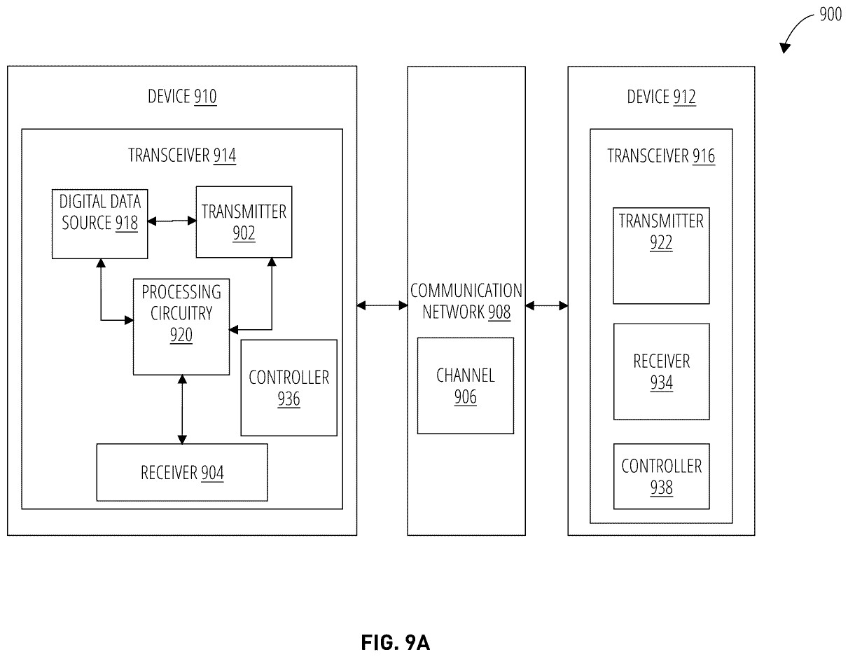

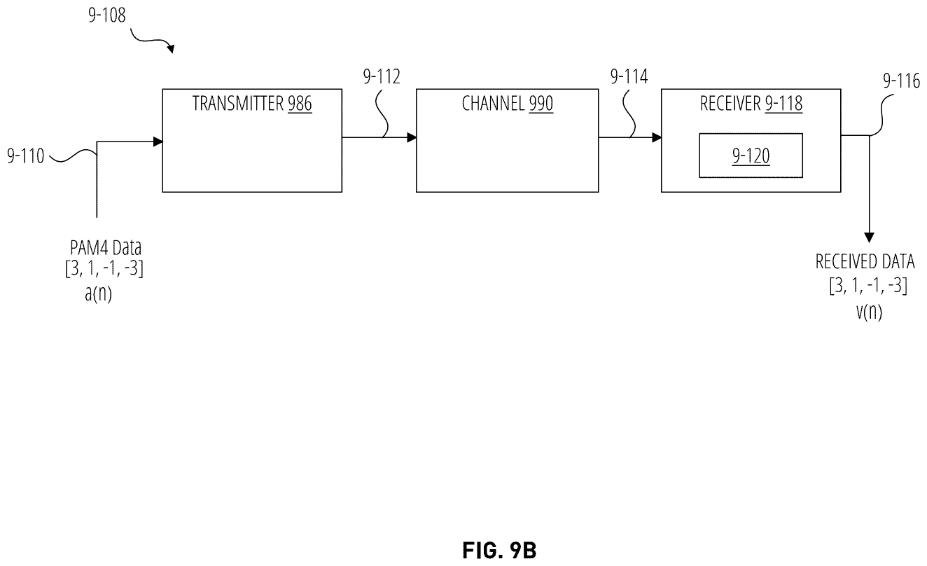

FIG. 9A illustrates an example communication system 900 with a controller 936, in accordance with at least some embodiments. In at least some embodiments, the communication system 900 may include the link training logic 104 as described herein. The link training logic 104 may be used to train one or more SerDes channels of the communication system 900. The communication system 900 includes a device 910, a communication network 908 including a communication channel 906, and a device 912. In at least one embodiment, the devices 910 and 912 are integrated circuits of a Personal Computer (PC), a laptop, a tablet, a smartphone, a server, a collection of servers, or the like. In some embodiments, the devices 910 and 912 may correspond to any appropriate type of device that communicates with other devices also connected to a common type of communication network 908. According to embodiments, the transmitter 902 and 922 of devices 910 or 912 may correspond to transmitters of a Graphics Processing Unit (GPU), a switch (e.g., a high-speed network switch), a network adapter, a central processing unit (CPU), a data processing unit (DPU), etc.

Examples of the communication network 908 that may be used to connect the devices 910 and 912 include wires, conductive traces, bumps, terminals, optical fibers, or the like. In other embodiments, the communication network 908 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 108 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 908 is a network that enables data transmission between the devices 910 and 912 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver with the controller In at least one embodiment, a system for high-speed network communication includes a processing unit, a network interface comprising a receiver or transceiver with controller or other processing device to optimize link training processes, as described herein. The processing unit can include a CPU, a GPU, a DPU, a network adapter, a network switch, an NVLink switch, or the like. Other examples for the communication network 908 can include other chip-to-chip or die-to-die interconnects, such as GRS, LPI (low power interface) or LLI (low latency interface).

The device 910 includes a transceiver 914 for sending and receiving signals, for example, data signals. The data signals may be digital or optical signals modulated with data or other suitable signals for carrying data.

The transceiver 914 may include a digital data source 918, a transmitter 2402, a receiver 904, and processing circuitry 920 that controls the transceiver 914. The digital data source 918 may include suitable hardware and/or software for outputting data in a digital format (e.g., in binary code and/or thermometer code). The digital data output by the digital data source 918 may be retrieved from memory (not illustrated) or generated according to input (e.g., user input).

The transceiver 914 includes suitable software and/or hardware for receiving digital data from the digital data source 918 and outputting data signals according to the digital data for transmission over the communication network 908 to a transceiver 916 of device 912.

The receiver 904 of device 910 may include suitable hardware and/or software for receiving signals, for example, data signals from the communication network 908. For example, the receiver 904 may include components for receiving processing signals to extract the data for storing in a memory. In at least one embodiment, the transceiver 916 includes a transmitter 922 and receive 934. The transceiver 916 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC.

The processing circuitry 920 may comprise software, hardware, or a combination thereof. For example, the processing circuitry 920 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 920 may comprise hardware, such as an Application-Specific Integrated circuit (ASIC). Other non-limiting examples of the processing circuitry 920 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 920 may be provided on a Printed Circuit Board (PCB) or collection of PCBs. It should be appreciated that any appropriate type of electrical component or collection of electrical components may be suitable for inclusion in the processing circuitry 920. The processing circuitry 920 may send and/or receive signals to and/or from other elements of the transceiver 914 to control the overall operation of the transceiver 914.

The transceiver 914 or selected elements of the transceiver 914 may take the form of a pluggable card or controller for the device 910. For example, the transceiver 914 or selected elements of the transceiver 914 may be implemented on a network interface card (NIC).

The device 912 may include a transceiver 916 for sending and receiving signals, for example, data signals over a channel 906 of the communication network 908. The channel 2406 can be PCIe, NVLink, Ethernet, InfiniBand, Ground Reference Signal (GRS), Chip-to-Chip (C2C), Die-to-Die (D2D), or the like. The same or similar structure of the transceiver 914 may be applied to transceiver 916, and thus, the structure of transceiver 916 is not described separately.

Although not explicitly shown, it should be appreciated that devices 910 and 912 and the transceiver 914 and transceiver 916 may include other processing devices, storage devices, and/or communication interfaces generally associated with computing tasks, such as sending and receiving data.

FIG. 9B illustrates a block diagram of an example communication system 9-108 employing a receiver 9-118 with a controller 9-120, according to at least one embodiment. In the example shown in FIG. 9B, a Pulse Amplitude Modulation level-4 (PAM4) modulation scheme is employed with respect to the transmission of a signal (e.g., digitally encoded data) from a transmitter (TX) 986 to a receiver (RX) 9-118 via a communication channel 990 (e.g., a transmission medium). The communication channel 2406 can be PCIe, NVLink, Ethernet, InfiniBand, GRS, C2C, D2D, or the like. According to embodiments, the transmitter 986 and receiver 9-118 may each include the link training logic 104 as described herein. In this example, the transmitter 986 receives an input data 9-110 (i.e., the input data at time n is represented as “a(n)”), which is modulated in accordance with a modulation scheme (e.g., PAM4) and sends the signal 9-112 a(n) including a set of data symbols (e.g., symbols −3, −1, 1, 3, where the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, PAM3, PAM7, PAM8, PAM16, etc. For example, for an NRZ-based system, the transmitted data symbols consist of symbols −1 and 1, with each symbol value representing a binary bit. This is also known as a PAM level −2 or PAM2 system as there are 2 unique values of transmitted symbols. Typically, a binary bit 0 is encoded as −1, and a bit 1 is encoded as 1 as the PAM2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 990 is a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 990 can be over serial links (e.g., a cable, PCB traces, copper cables, optical fibers, or the like), read channels for data storage (e.g., hard disk, flash solid-state drives (SSDs), high-speed serial links, deep space satellite communication channels, applications, or the like. The receiver (RX) 9-118 receives an incoming signal 9-114 over the channel 990. The receiver 9-118 can output a received signal 9-116, “v(n),” including the set of data symbols (e.g., symbols −3, −1, 1, 3, wherein the symbols represent coded binary data).

In at least one embodiment, the transmitter 986 can be part of a SerDes IC. The SerDes IC can be a transceiver that converts parallel data to serial data and vice versa. The SerDes IC can facilitate transmission between two devices over serial streams, reducing the number of data paths, wires/traces, terminals, etc. The receiver 9-118 can be part of a SerDes IC. The SerDes IC can include a clock-recovery circuit. The clock-recovery circuit can be coupled to an ADC and an equalization block. In another embodiment, the SerDes IC can include additional equalization block before a symbol detector. In at least some embodiments, the SerDes IC may include some or all of the features of the link training logic 104 as described herein.

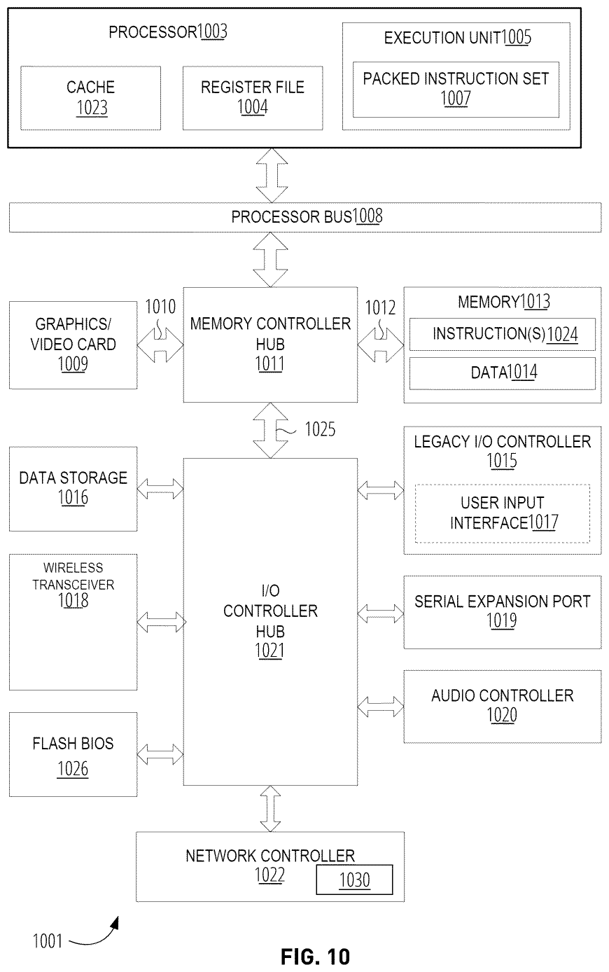

FIG. 10 illustrates an example computer system 1001, including an error correction circuit 1030, in accordance with at least some embodiments. In at least one embodiment, computer system 1001 may be a system with interconnected devices and components, an SOC, or some combination. In at least one embodiment, computer system 1001 is formed with a processor 1003 that may include execution units to execute an instruction. In at least one embodiment, computer system 1001 may include, without limitation, a component, such as a processor 1003, to employ execution units including logic to perform algorithms for processing data. In at least one embodiment, computer system 1001 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1001 may execute a version of WINDOWS′ operating system available from Microsoft Corporation of Redmond, Wash., although other operating systems (UNIX and Linux, for example), embedded software, and/or graphical user interfaces, may also be used.

In at least one embodiment, computer system 1001 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 1001 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 1001 may include, without limitation, processor 1003 that may include, without limitation, one or more execution units 1005 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 1001 is a single processor desktop or server system. In at least one embodiment, computer system 1001 may be a multiprocessor system. In at least one embodiment, processor 1003 may include, without limitation, a CISC microprocessor, a RISC microprocessor, a VLIW microprocessor, and a processor implementing a combination of instruction sets, or any other processor device, such as a digital signal processor, for example. In at least one embodiment, processor 1003 may be coupled to a processor bus 1008 that may transmit data signals between processor 1003 and other components in computer system 1001.

In at least one embodiment, processor 1003 may include, without limitation, a Level 1 (“L1”) internal cache memory (“cache”) 1023. In at least one embodiment, processor 1003 may have a single internal cache or multiple levels of internal cache. In at least one embodiment, cache memory may reside external to processor 1003. In at least one embodiment, processor 1003 may also include a combination of both internal and external caches. In at least one embodiment, a register file 1004 may store different types of data in various registers including, without limitation, integer registers, floating point registers, status registers, and instruction pointer register.

In at least one embodiment, execution unit 1005, including, without limitation, logic to perform integer and floating point operations, also resides in processor 1003. Processor 1003 may also include a microcode (“ucode”) read only memory (“ROM”) that stores microcode for certain macro instructions. In at least one embodiment, execution unit 1005 may include logic to handle a packed instruction set 1007. In at least one embodiment, by including packed instruction set 1007 in an instruction set of a general-purpose processor 1003, along with associated circuitry to execute instructions, operations used by many multimedia applications may be performed using packed data in a general-purpose processor 1003. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 1006 may also be used in microcontrollers, embedded processors, graphics devices, DSPs, and other types of logic circuits. In at least one embodiment, computer system 1001 may include, without limitation, a memory 1013. In at least one embodiment, memory 1013 may be implemented as a DRAM device, an SRAM device, flash memory device, or other memory devices. Memory 1013 may store instruction(s) 1024 and/or data 1014 represented by data signals that may be executed by processor 1003.

In at least one embodiment, a system logic chip may be coupled to a processor bus 1008 and memory 1013. In at least one embodiment, the system logic chip may include, without limitation, a memory controller hub (“MCH”) 1011, and processor 1003 may communicate with MCH 1011 via processor bus 1008. In at least one embodiment, MCH 1011 may provide a high bandwidth memory path 1012 to memory 1013 for instruction and data storage and for storage of graphics commands, data, and textures. In at least one embodiment, MCH 1011 may direct data signals between processor 1003, memory 1013, and other components in computer system 1001 and may bridge data signals between processor bus 1008, memory 1013, and a system I/O 1025. In at least one embodiment, a system logic chip may provide a graphics port for coupling to a graphics controller. In at least one embodiment, MCH 1011 may be coupled to memory 1013 through high bandwidth memory path 1012, and graphics/video card 1009 may be coupled to MCH 1011 through an Accelerated Graphics Port (“AGP”) interconnect 1010.

In at least one embodiment, computer system 1001 may use system I/O 1025 that is a proprietary hub interface bus to couple MCH 1011 to I/O controller hub (“ICH”) 1021. In at least one embodiment, ICH 1021 may provide direct connections to some I/O devices via a local I/O bus. In at least one embodiment, a local I/O bus may include, without limitation, a high-speed I/O bus for connecting peripherals to memory 1013, a chipset, and processor 1003. Examples may include, without limitation, an audio controller 1020, a firmware hub (“flash BIOS”) 726, a wireless transceiver 1018, a data storage 1016, a legacy I/O controller 1015 containing a user input interface 1017, a keyboard interface, a serial expansion port 1019, such as a USB, and a network controller 1022. In at least one embodiment, the network controller 1022 includes the error correction circuit 1030. Data storage 1016 may comprise a hard disk drive, a floppy disk drive, a CD-ROM device, a flash memory device, or other mass storage device.

In at least one embodiment, FIG. 10 illustrates a system, which includes interconnected hardware devices or “chips.” In at least one embodiment, FIG. 10 may illustrate an example SoC. In at least one embodiment, devices illustrated in FIG. 10 may be interconnected with proprietary interconnects, standardized interconnects (e.g., PCIe), or some combination thereof. In at least one embodiment, one or more components of system 1002 are interconnected using compute express link (“CXL”) interconnects.

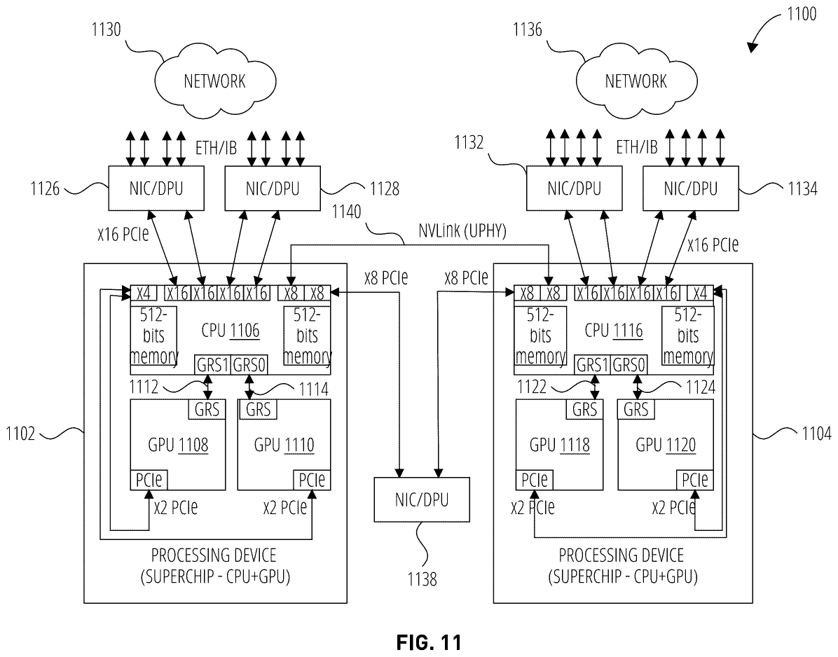

FIG. 11 is a block diagram of a computing system 1100 having two processing devices coupled to each other and multiple networks according to at least one embodiment. The computing system 1100 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 1100. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 1100 highly suitable for demanding applications that require significant processing power, such as artificial intelligence (AI), machine learning (ML), and data-intensive computing, while ensuring robust connectivity and scalability across various networked environments. The integrated circuits of the computing system 1100 can include one or more CPUs and one or more GPUs. An example architecture of a multi-GPU architecture is illustrated in FIG. 11.

As illustrated in FIG. 11, the computing system 1100 includes a processing device 1102 with a multi-GPU architecture. In particular, the processing device 1102 includes a CPU 1106, a GPU 1108, and a GPU 1110. The CPU 1106 can be coupled to the GPU 1108 via an die-to-die (D2D) or chip-to-chip (C2C) interconnect 1112, such as a Ground-Referenced Signaling interconnect (GRS interconnect). The CPU 1106 can be coupled to the GPU 1110 via a D2D or C2C interconnect 1114. The CPU 1106 can also couple to the GPU 1108 and GPU 1110 via PCIe interconnects. The CPU 1106 can be coupled to one or more network interface cards (NICs) or data processing units (DPUs), which are coupled to one or more networks. For example, as illustrated in FIG. 11, the CPU 1106 is coupled to a first NIC/DPU 1126, which is coupled to a network 1130. The CPU 1106 is also coupled to a second NIC/DPU 1128, which is coupled to the network 1130. The NIC/DPU 1126 and NIC/DPU 1128 can be coupled to the network 1130 over Ethernet (ETH) or InfiniBand (IB) connections.

The computing system 1100 also includes a processing device 1104 with a multi-GPU architecture. In particular, the processing device 1104 includes a CPU 1116, a GPU 1118, and a GPU 1120. The CPU 1116 can be coupled to the GPU 1118 via an D2D or C2C interconnect 1122. The CPU 1116 can be coupled to the GPU 1120 via a D2D or C2C interconnect 1124. The CPU 1116 can also couple to the GPU 1118 and GPU 1120 via PCIe interconnects. The CPU 1116 can be coupled to one or more NICs or DPUs, which are coupled to one or more networks. For example, as illustrated in FIG. 11, the CPU 1116 is coupled to a first NIC/DPU 1132, which is coupled to a network 1136. The CPU 1116 is also coupled to a second NIC/DPU 1134, which is coupled to the network 1136. The NIC/DPU 1132 and NIC/DPU 1134 can be coupled to the network 1136 over Ethernet (ETH) or InfiniBand (IB) connections.

In at least one embodiment, the processing device 1102 and the processing device 1104 can communication with each other via a NIC/DPU 1138, such as over PCIe interconnects. The processing device 1102 and processing device 1104 can also communicate with each other over a high-bandwidth communication interconnects 1140, such as an NVLink interconnect or other high-speed interconnects. The NIC/DPUs of FIG. 11 can be the various embodiments of the DPUs described herein.

In at least one embodiment, the computing system 1100 is used for high-speed network communication and includes a processing unit (e.g., CPU 1106, GPU 1108, GPU 1110, CPU 1116, GPU 1118, GPU 1120, NIC/DPU 1126, NIC/DPU 1128, NIC/DPU 1132, NIC/DPU 1134, or NIC/DPU 1138), and a network interface coupled to the processing unit. The network interface can include the operations and functionality of the DPUs described herein.

In at least one embodiment, the computing system 1100 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

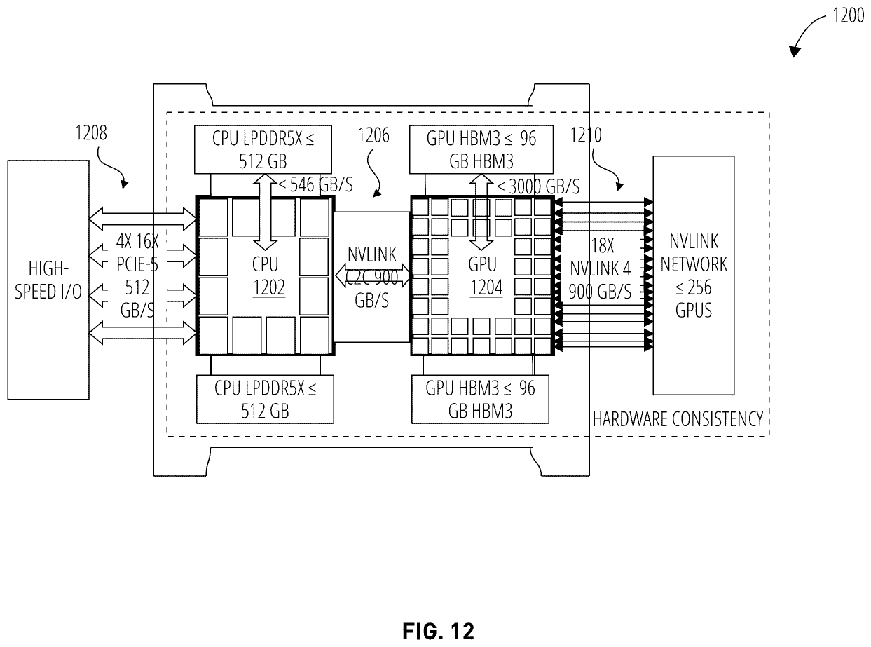

FIG. 12 is a block diagram of a computing system 1200 having a CPU 1202 and a GPU 1204 in a single integrated circuit according to at least one embodiment. The computing system 1200 can be a highly integrated design where a CPU 1202 and GPU 1204 are connected on a single integrated circuit, utilizing an NVLink C2C (Chip-to-Chip) interconnect 1206 to enable fast, low-latency communication between the two processing units. This close integration allows for efficient data transfer and parallel processing between the CPU 1202 and GPU 1204, optimizing performance for complex computational tasks. The GPU elements within the computing system 1200 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1210. Additionally, the computing system 1200 can be designed to interface with a high-speed I/O through PCIe interconnects 1208, ensuring rapid data transfer to and from external devices, further enhancing the system's capabilities in handling data-intensive tasks and providing robust connectivity to peripheral components. It should be noted that the C2C interconnects 1206 can be considered D2D interconnects since the CPU 1202 and the GPU 1204 are located on the same integrated circuit. The integrated circuit can include CPU memory (also referred to as main memory) and GPU memory, which are accessible by the CPU 1202 and the GPU 1204, respectively, over high-speed interconnects. The computing system 1200 can bring together performance of the GPU 1204 with the versatility of the CPU 1202. The CPU 1202 can be connected with a high-bandwidth and memory coherent C2C interconnects 1206 in a single integrated circuit. The computing system 1200 can support a link switch system.

In at least one embodiment, the computing system 1200 is used for high-speed network communication and includes a processing unit, and a network interface coupled to the processing unit. The network interface can include the operations and functionality of the DPUs described herein.

In at least one embodiment, the computing system 1200 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

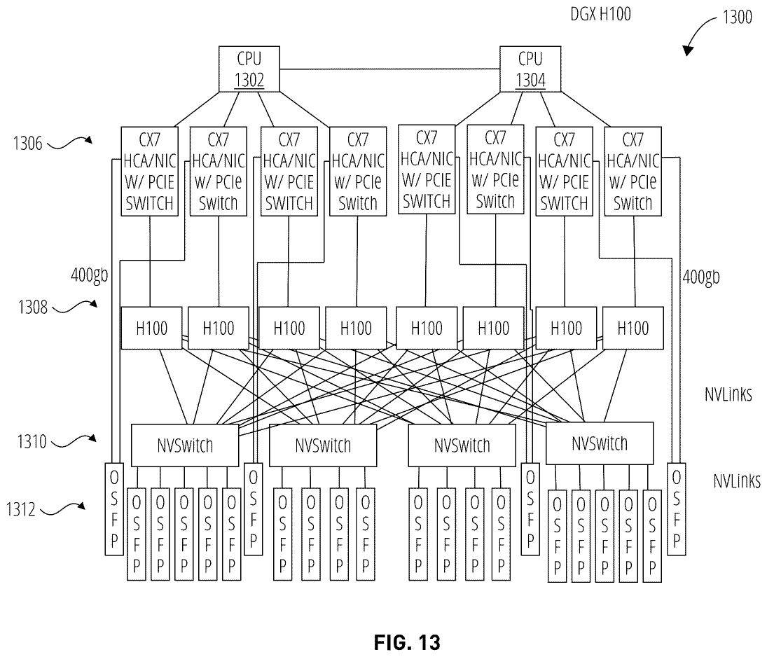

FIG. 13 is a block diagram of a computing system 1300 having tensor core GPUs 1308 according to at least one embodiment. The computing system 1300 can be a DGX H100 system, which is a high-performance computing platform designed to meet the demands of AI, ML, and deep learning (DL) workloads. The computing system 1300 can include multiple tensor core GPUs 1308 (e.g., NVIDIA H100 Tensor Core GPUs). The tensor core GPUs 1308 can be optimized for AI/ML/DL applications, offering exceptional performance for deep learning training, inference, and high-performance computing tasks. The tensor core GPUs 1308 within the computing system 1300 are interconnected using high-speed communication interfaces like NVLinks, enabling rapid data transfer between them, which is crucial for handling large-scale AI models and datasets with low latency. This computing system 1300 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1308, the computing system 1300 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1308 for their specific applications. The computing system 1300 is ideally suited for large-scale AI model training, real-time inference, scientific simulations, data analytics, and other compute-intensive tasks that require massive parallel processing power.

The tensor core GPUs 1308 can be coupled to multiple CPUs, such as CPU 1302 and CPU 1304, using switches 1306 (e.g., CX7 HCA/NIC with PCIe switch). The tensor core GPUs 1308 can be coupled to each other via switches 1310 (e.g., NVSwitches). The switches 1306 and switches 1310 can be coupled to high-speed transceiver modules 1312. The high-speed transceiver modules 1312 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1300 remains capable of meeting increasing data demands and can be upgraded to support future advancements in network speeds, thus contributing to the system's overall performance and scalability.

In at least one embodiment, the computing system 1300 can be considered a data-network configuration with full-bandwidth intra-server NVLinks. In this example, all eight tensor core GPUs 1308 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1308 can half-subscribe eighteen NVLinks to GPUs in other servers. Four tensor core GPUs 1308 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1308 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

In at least one embodiment, the computing system 1300 is used for high-speed network communication and includes a processing unit (e.g., CPU 1302, CPU 1304, switches 1306, tensor core GPUs 1308, switches 1310, high-speed transceiver modules 1312), and a network interface coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 1300 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors —for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still CO-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
initiating a link training process to train a transmitter equalizer;
receiving a first block of data comprising a plurality of pages of data each associated with tap settings of the transmitter equalizer;
sending a first acknowledgement message that indicates correct receipt of the first block of data; and
after sending the first acknowledgement message, receiving a second block of data comprising one or more pages of data each associated with the tap settings of the transmitter equalizer.

2. The method of claim 1, wherein receiving the first block of data comprises:
receiving a first page of the plurality of pages of data, the first page comprising a first control field that indicates whether the first page is a first-received page of a message, a last-received page of the message, or a page between the first-received page and the last-received page of the message, and a second control field that indicates whether the first page comprises more than three payload bits.

3. The method of claim 2, wherein receiving the first block of data comprises:
receiving a first page of the plurality of pages of data, the first page comprising a first page control value, wherein the first page control value indicates that the first page is a first-received page of data corresponding to the tap settings of the transmitter equalizer; and
successively receiving, subsequent to the first page, remaining pages of the plurality of pages of data, wherein the remaining pages of data alternately comprise one of a second page control value or a third page control value based on an order in which the remaining pages are received, and wherein the second page control value is different from the first page control value and the third page control value is different from the first and second page control values.

4. The method of claim 3, wherein receiving the second block of data comprises:
receiving a second page of the plurality of pages of data, the second page comprising a fourth page control value different from the first, second, and third page control values, wherein the fourth page control value indicates that the second page is a last-received page of data corresponding to the tap settings of the transmitter equalizer.

5. The method of claim 1, wherein receiving the first block of data comprises:
receiving a first page of the plurality of pages of data comprising a first page control value, the first page control value indicating that the first page is an initial page of data corresponding to the tap settings of the transmitter equalizer;
receiving, immediately following the first page, a second page of the plurality of pages of data comprising a second page control value different from the first page control value, wherein the second page control value indicates that the second page corresponds to the tap settings of the transmitter equalizer; and
receiving, immediately following the second page, a third page of the plurality of pages of data comprising a third page control value different from the first and second page control values, wherein the third page control indicates that the third page corresponds to the tap settings of the transmitter equalizer.

6. The method of claim 5, wherein receiving the first block of data further comprises:
receiving, after the third page, a fourth page of the plurality of pages of data comprising the second page control value, wherein the second page control value indicates that the fourth page corresponds to the tap settings of the transmitter equalizer.

7. The method of claim 5, wherein receiving the second block of data comprises:
receiving a fourth page of the plurality of pages of data comprising a fourth page control value different from the first, second, and third page control values, wherein the fourth page control value indicates that the fourth page is a last page of data corresponding to the tap settings of the transmitter equalizer.

8. The method of claim 1, wherein the second block comprises a second plurality of pages of data, and wherein the method further comprises:
sending a second acknowledgement message that indicates incorrect receipt of the second block of data;
re-receiving the second block;
sending a third acknowledgement message that indicates correct receipt of the second block of data; and
after sending the third acknowledgement message, receiving a third block of data comprising one or more pages of data each associated with the tap settings of the transmitter equalizer.

9. A device comprising:
a transmitter equalizer;
one or more processors; and
memory storing instructions that, when executed by the one or more processors, cause the device to:
initiate a link training process to train a transmitter equalizer;
receive a first block of data comprising a plurality of pages of data each associated with tap settings of the transmitter equalizer;
send a first acknowledgement message that indicates correct receipt of the first block of data; and
after sending the first acknowledgement message, receive a second block of data comprising one or more pages of data each associated with the tap settings of the transmitter equalizer.

10. The device of claim 9, wherein to receive the first block of data, the instructions cause the device to:
receive a first page of the plurality of pages of data, the first page comprising a first page control value, wherein the first page control value indicates that the first page is a first-received page of data corresponding to the tap settings of the transmitter equalizer; and
successively receive, subsequent to the first page, remaining pages of the plurality of pages of data, wherein the remaining pages of data alternately comprise one of a second page control value or a third page control value based on an order in which the remaining pages are received, and wherein the second page control value is different from the first page control value and the third page control value is different from the first and second page control values.

11. The device of claim 10, wherein to receive the second block of data, the instructions cause the device to:
receive a second page of the plurality of pages of data, the second page comprising a fourth page control value different from the first, second, and third page control values, wherein the fourth page control value indicates that the second page is a last-received page of data corresponding to the tap settings of the transmitter equalizer.

12. The device of claim 9, wherein to receive the first block of data, the instructions cause the device to:
receive a first page of the plurality of pages of data comprising a first page control value, the first page control value indicating that the first page is an initial page of data corresponding to the tap settings of the transmitter equalizer;
receive, immediately following the first page, a second page of the plurality of pages of data comprising a second page control value different from the first page control value, wherein the second page control value indicates that the second page corresponds to the tap settings of the transmitter equalizer; and
receive, immediately following the second page, a third page of the plurality of pages of data comprising a third page control value different from the first and second page control values, wherein the third page control value indicates that the third page corresponds to the tap settings of the transmitter equalizer.

13. The device of claim 12, wherein to receive the first block of data, the instructions further cause the device to:
receive, after the third page, a fourth page of the plurality of pages of data comprising the second page control value, wherein the second page control value indicates that the fourth page corresponds to the tap settings of the transmitter equalizer.

14. The device of claim 12, wherein to receive the second block of data, the instructions cause the device to:
receive a fourth page of the plurality of pages of data comprising a fourth page control value different from the first, second, and third page control values, wherein the fourth page control value indicates that the fourth page is a last page of data corresponding to the tap settings of the transmitter equalizer.

15. The device of claim 9, wherein the second block comprises a second plurality of pages of data, and wherein the instructions further cause the device to:
send a second acknowledgement message that indicates incorrect receipt of the second block;
re-receive the second block;
send a third acknowledgement message that indicates correct receipt of the second block; and
after sending the third acknowledgement message, receive a third block comprising one or more pages of data each associated with the tap settings of the transmitter equalizer.

16. A method comprising:
receiving a transmission from a peer transmitter comprising a transmitter equalizer;
generating tap configuration data based on the transmission;
generating a training message comprising the tap configuration data, wherein the training message comprises a plurality of blocks of data, and wherein each of the plurality of blocks of data comprises a plurality of pages of data;
sending a first block of data of the plurality of blocks of data to the peer transmitter;
receiving, from the peer transmitter, a first acknowledgement message that indicates correct receipt of the first block of data; and
based on the first acknowledgement message, sending a second block of data of the plurality of blocks of data of data to the peer transmitter.

17. The method of claim 16, further comprising:
waiting to transmit data to the peer transmitter until receiving the first acknowledgement message.

18. The method of claim 16, further comprising:
receiving, from the peer transmitter, a second acknowledgement message that indicates incorrect receipt of the second block of data; and
based on the second acknowledgement message, resending the second block of data to the peer transmitter.

19. The method of claim 16, wherein generating the training message comprises assigning each page of the training message a page control value such that no page comprises a same page control value as an immediately previous page.

20. The method of claim 16, wherein generating the training message comprises:
generating a first page of the first block of data, the first page comprising a first page control value that indicates that the first page is an initial page of the training message;
generating a second page of the first block of data to follow the first page, the second page comprising a second page control value different from the first page control value; and
generating a third page of the first block of data to follow the second page, the third page comprising a third page control value different from the first and second page control values.

21. A device comprising:
a transmitter equalizer;
one or more processors; and
memory storing instructions that, when executed by the one or more processors, cause the device to:
receive, from a peer receiver, a message comprising at least three pages of data, wherein each of the pages comprises a page control field that identifies whether each respective page is a first-received page of the message, a last-received page of the message, or a page of the message received between the first-received and last-received pages of the message; and
based on the data of message, configure tap settings of the transmitter equalizer.

22. The device of claim 21, wherein sequentially-received pages of the message do not share a same value within respective page control fields.

23. The device of claim 21, wherein pages of the message that are received between the first-received and last-received pages of the message additionally comprise a second page control field that indicates whether the respective page comprises more than three payload bits.

24. The device of claim 21, wherein to receive the message, the instructions cause the device to:
receive a first page of a message, the first page comprising a first page control field value that indicates that the first page is the first-received page of the message;
receive a second page of the message, the second page comprising a second page control field value that indicates that the second page is received between the first-received and last-received pages of the message; and
receive a third page of the message, the third page comprising a third page control field value that indicates that the third page is the last-received page of the message.

25. The device of claim 24, wherein the instructions further cause the device to:
receive, immediately after receiving the second page, a fourth page of the message, the fourth page comprising a fourth page control field value that indicates that the fourth page is received subsequent to the first page, wherein the fourth page control field value is different from the second page control field value.
